(19) United States
(12) Patent Application Publication
(10) Pub. No.: US 2026/0067087 A1
(43) Pub. Date: Mar. 5, 2026

(54) AI Reputation Oracle for Tokenized Creator Influence

(71) Applicant: George William Bickerstaff, III, Greenwich, CT (US)

(72) Inventor: George William Bickerstaff, III, Greenwich, CT (US)

(21) Appl. No.: 19/377,771

(22) Filed: Nov. 3, 2025

(51) Int. Cl. H04L 9/32; H04L 9/00

(52) U.S. Cl. CPC H04L 9/3213; H04L 9/3218; H04L 9/50

(57) ABSTRACT

A computer-implemented system converts verified digital-influence data into blockchain tokens with cryptographically anchored reputation scores. The system aggregates at least 1,200 signals per cycle, validated by a decentralized Scoring Committee, and embeds the verified score as a Score Anchor in each token. Transactions use a Premium Purchase Function that executes atomic, three-times (3×) royalties for high-reputation creators. A Drift Guard prevents artificial inflation, a Regulator Dashboard enables audit reconstruction, and Governance Contracts ensure adaptive AI model updates as technologies and market needs evolve.

### FIELD OF THE INVENTION

The present invention relates to decentralized artificial intelligence systems for influence verification, tokenization, and programmable royalty automation. More specifically, it concerns a computer-implemented framework that converts verified creator reputation data into tradable digital assets with adaptive scoring, dynamic premium payouts, and real-time regulatory auditability.

### DEFINITIONS

Reputation Oracle (110): A cryptographically trusted AI service that continuously evaluates and attests to a creator's off-chain influence using multiple verified data sources.
Score Anchor (140): An immutable metadata field within a token that stores and updates the creator's most recent reputation score.
Scoring Committee (120): A decentralized network of at least twenty-one independent nodes that must achieve two-thirds consensus to validate a reputation score.
Drift Guard (310): A verification mechanism that pauses the publication of any reputation score change greater than or equal to fifteen (15) points until independent proof of a legitimate viral event is confirmed.
Premium Purchase Function (430): A smart contract that executes an atomic royalty payment, multiplying the creator's payout up to three times (3×) when the Score Anchor value is greater than or equal to ninety (90).
Regulator Dashboard (510): A secure audit interface that allows third parties to reconstruct transaction, scoring, and payment histories from on-chain data.
Governance Contracts (610): Smart-contract logic that authorizes new data sources, adjusts model and signal parameters, and approves updates without system downtime.

### BACKGROUND OF THE INVENTION

Existing influencer markets rely on platform-specific, unverifiable engagement metrics.

Creators receive inconsistent rewards, while advertisers overpay for unreliable impressions.

Prior blockchain systems tokenize content, but none integrate verified reputation scoring, consensus validation, automated premium payouts, and adaptive governance into a unified protocol.

The present invention solves these deficiencies by combining AI-driven verification, decentralized consensus, tokenized reputation anchoring, and transparent regulator interfaces.

### SUMMARY OF THE INVENTION

The invention introduces an AI Reputation Oracle that verifies creator influence using thousands of signals, validated through decentralized consensus.

Verified scores are permanently embedded within token metadata via the Score Anchor field.

A Premium Purchase Function automatically executes atomic payouts during qualifying transactions, tripling royalties when a verified score meets or exceeds ninety (90).

A Drift Guard mechanism prevents fraudulent score inflation.

A Regulator Dashboard provides real-time audit and reconstruction capabilities.

Governance Contracts enable adaptive metric updates based on evolving technologies and market needs, ensuring long-term system flexibility.

### BRIEF DESCRIPTION OF THE DRAWINGS

FIG. 1: System Architecture (110-160)

FIG. 2: Data Aggregation and Scoring Cycle (210-260)

FIG. 3: Premium Royalty Execution Flow (310-360)

FIG. 4: Brand Transaction Example (410-460)

FIG. 5: Drift Guard and Compliance Sequence (510-560)

FIG. 6: Governance and Adaptation Framework (610-660)

### DETAILED DESCRIPTION

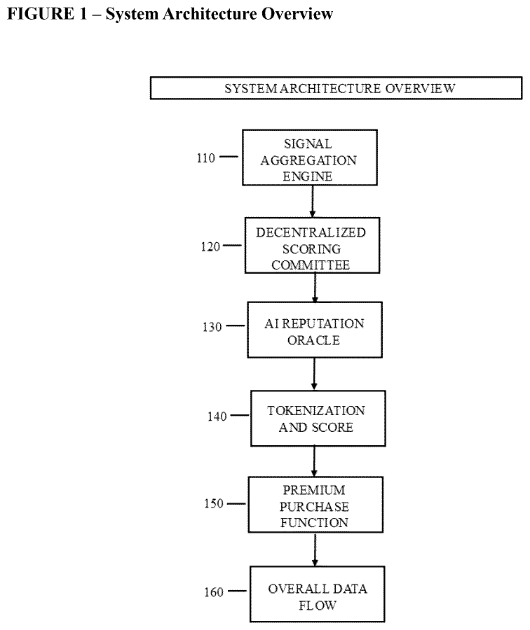

### FIG. 1—System Architecture (110-160)

The system integrates a Signal Aggregation Engine (110), Decentralized Scoring Committee (120), Tokenization Module (140), and Reputation Oracle (160).

The architecture ensures every component communicates through cryptographically signed API calls, supporting upgradeable smart contracts and interoperability across blockchain networks.

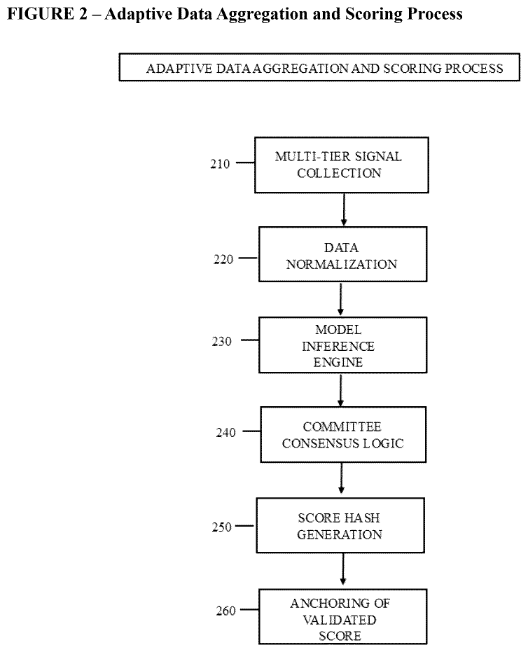

### FIG. 2—Data Aggregation and Scoring Cycle (210-260)

The Signal Aggregation Engine (210) collects, in one embodiment, at least one thousand two hundred (1,200) metrics per six-hour cycle.

Signals include platform APIs, on-chain events, engagement authenticity, sentiment analysis, and growth velocity.

A Decentralized Scoring Committee (240) validates results via a two-thirds consensus, using EIP-712 signatures.

Governance Contracts (610) permit dynamic adjustment of signal weightings and measurement intervals as technologies evolve.

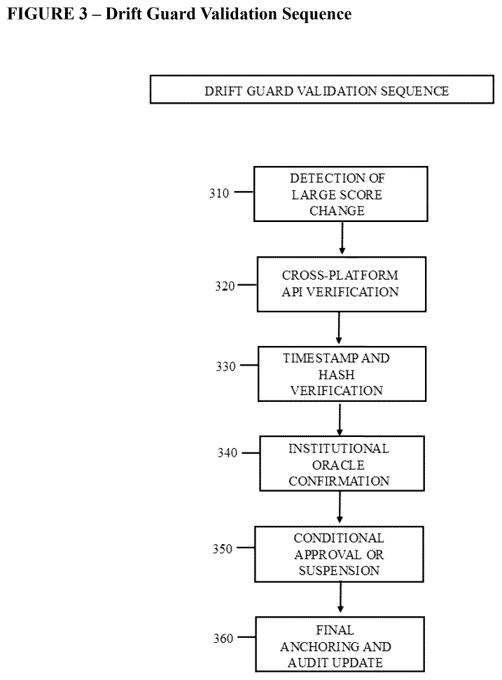

### FIG. 3—Premium Royalty Execution Flow (310-360)

The Premium Purchase Function (430) checks each token's Score Anchor (420) during a transaction.

If the score is ninety (90) or higher, the creator's royalty is multiplied up to three times (3×).

A one-twentieth ( 1/20) service allocation funds the Scoring Committee's node operations.

The transaction executes atomically within the same blockchain block, ensuring verifiable, fraud-resistant settlement.

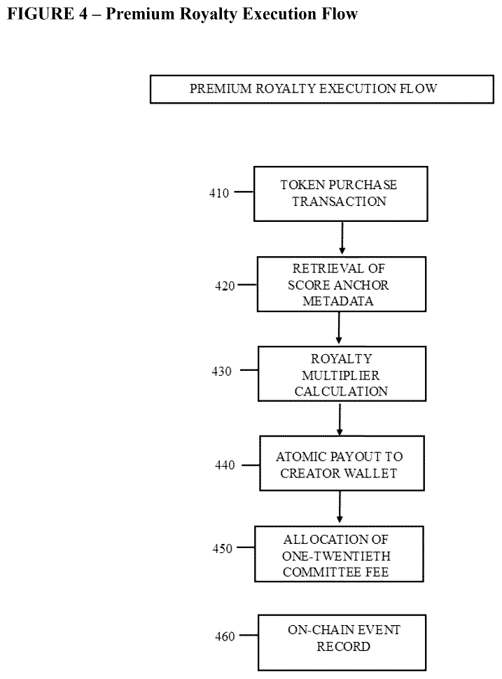

### FIG. 4—Brand Transaction Example (410-460)

In one embodiment, a verified brand wallet purchases a creator token displaying a Score Anchor of ninety-four (94).

The Premium Purchase Function executes instantly; the audit trail and payment proof are logged on-chain.

The event log emits “Premium CPM 3×” to mark successful premium execution.

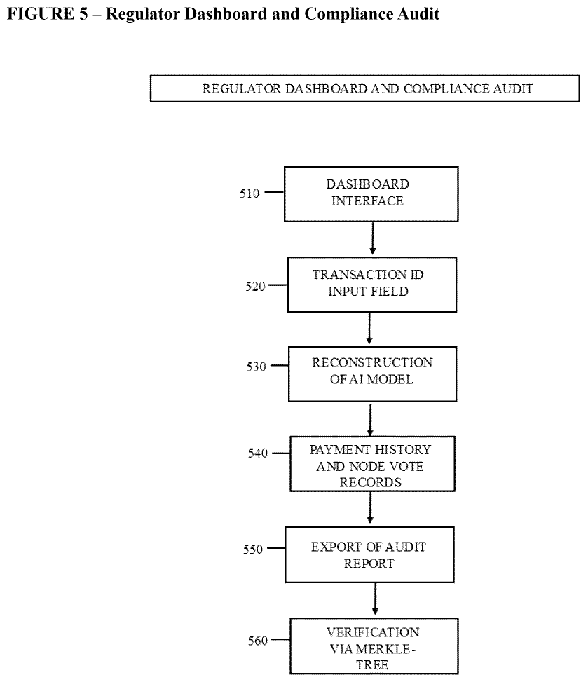

### FIG. 5—Drift Guard and Compliance (510-560)

The Drift Guard protocol detects anomalies exceeding fifteen (15) points.

When triggered, it halts publication until independent verification from at least three separate data oracles confirms a genuine viral event.

The system employs zero-knowledge or Merkle proofs to validate data authenticity.

The Regulator Dashboard (510) reconstructs full histories for compliance audits using stored on-chain data.

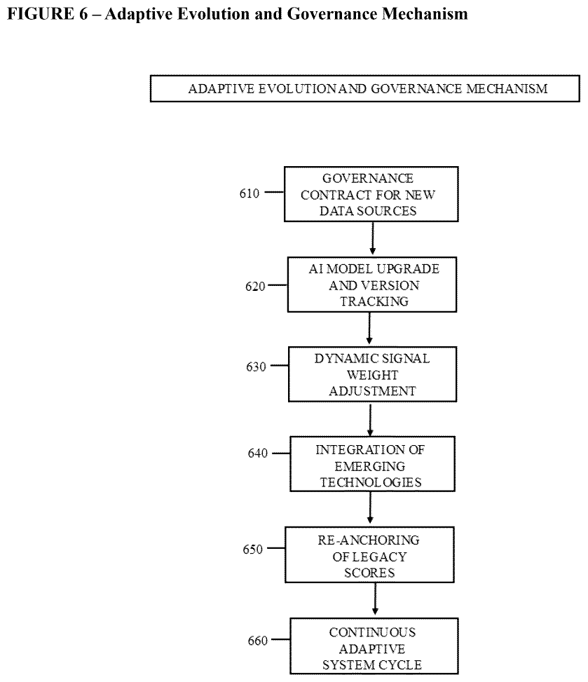

### FIG. 6—Governance and Adaptation (610-660)

Governance Contracts (610) authorize updates to data sources, signal tiers, and AI weighting models.

Adaptive AI logic (630) continuously retrains ensemble models—neural networks and gradient-boosted trees—on verified historical datasets.

Governance ensures that metric relevance, fairness, and compliance evolve alongside technological and market developments.

Historical data are re-anchored (650) to maintain continuity across algorithmic versions.

1. A computer-implemented system for AI-based reputation measurement and tokenization, comprising:
(a) a Signal Aggregation Engine (110, 210) configured to collect multi-tier data;
(b) a Decentralized Scoring Committee (120, 240) configured to validate AI-generated scores via consensus;
(c) a Tokenization Module (140, 260) configured to embed validated scores into blockchain metadata; and
(d) Governance Contracts (610-630) configured to adjust metrics, signal weightings, and algorithms to reflect technological and market changes.

2. A computer-implemented royalty automation system, comprising:
(a) a Drift Guard mechanism (310-360) configured to verify large score changes; and
(b) a Premium Purchase Function (150, 430) configured to execute an atomic payout based on a Score Anchor value (140, 420).

3. A computer-implemented compliance and audit system, comprising:
(a) a Regulator Dashboard (510-550) configured to reconstruct transaction and model data; and
(b) Governance Contracts (610-660) configured to maintain adaptive standards and audit integrity.

4. The system of claim 1, wherein the Signal Aggregation Engine (110, 210) collects at least one thousand two hundred (1,200) signals within a six-hour interval, the signal count and interval being dynamically adjustable through Governance Contracts.

5. The system of claim 1, wherein an AI model (230) comprises a neural network and a gradient-boosted tree ensemble trained on verified historical datasets.

6. The system of claim 2, wherein the Drift Guard sequence (310-360) is triggered when a score change exceeds fifteen (15) points, the threshold being adjustable through Governance Contracts.

7. The system of claim 2, wherein the Premium Purchase Function (150, 430) multiplies a creator royalty up to three times (3×) when the Score Anchor (140, 420) is greater than or equal to ninety (90).

8. The system of claim 2, wherein one-twentieth ( 1/20) of a premium payout funds operation of the Decentralized Scoring Committee (120).

9. The system of claim 3, wherein the Regulator Dashboard (510-550) exports audit reports in XML, JSON, or ISO 20022 format.

10. The system of claim 3, wherein integrity is verified using Merkle-tree proofs or zero-knowledge proofs to ensure that reconstructed data matches the original blockchain records.

11. The system of claim 3, wherein new data sources (610) are approved through Governance Contracts without service interruption, thereby supporting adaptive compliance.

12. The system of claim 1, wherein metrics and signal weights (630) are automatically rebalanced by adaptive AI governance to maintain fairness and relevance as technologies evolve.

13. The system of claim 3, wherein historical scores are re-anchored (650) while preserving audit continuity and traceability across successive algorithmic versions.
